(19) United States
(12) Patent Application Publication
(10) Pub. No.: US 2024/0262170 A1
(43) Pub. Date: Aug. 8, 2024

(54) AIR-CONDITIONING SYSTEM WITH ELECTROSTATIC FILTER, MOTOR VEHICLE HAVING SUCH AN AIR-CONDITIONING SYSTEM, AND METHOD FOR OPERATING SUCH AN AIR-CONDITIONING SYSTEM

(71) Applicant: AUDI AG, Ingolstadt (DE)

(72) Inventor: Karsten BELZ, Ingolstadt (DE)

(73) Assignee: AUDI AG, Ingolstadt (DE)

(21) Appl. No.: 18/563,972

(22) PCT Filed: Feb. 22, 2022
(86) PCT No.: PCT/EP2022/054328

§ 371 Date: Nov. 24, 2023

(30) Foreign Application Priority Data
May 31, 2021 (DE) 10 2021 114 015.3

(51) Int. Cl. B60H 3/00; B03C 3/36; B03C 3/68; B60H 3/06

(52) U.S. Cl. CPC B60H 3/0078; B03C 3/368; B03C 3/68; B60H 3/0608; B03C 2201/30

(57) ABSTRACT

An air conditioning system for a motor vehicle having an air conditioning unit that is configured to condition interior supply air; at least one air filter assigned to the air conditioning unit, a blower device configured to generate an air flow that is conducted to the air conditioning unit; at least one air supply duct connected to the blower device; at least one electrostatic filter arranged in the air supply duct upstream of the blower device; and a control device that is connected to the electrostatic filter. The control device is configured to control the operation of the electrostatic filter as a function of at least one detected air conditioning parameter and/or at least one vehicle status parameter.

### FIELD

The invention relates to an air conditioning system for a motor vehicle having an air conditioning unit that is configured to condition interior supply air; at least one air filter assigned to the air conditioning unit; a blower device configured to generate an air flow that is conducted to the air conditioning unit; at least one air supply duct connected to the blower device; at least one electrostatic filter arranged in the air supply duct upstream of the blower device; and having a control device that is connected to the electrostatic filter. The invention furthermore relates to a motor vehicle having such an air conditioning system and a method for operating such an air conditioning system.

### BACKGROUND

An electromechanical filter system for an air conditioning device is known from DE 10 2016 115 441 A1, in which a high-voltage supply is interrupted when the air conditioning device is opened.

DE 10 2011 007 351 A1 discloses an air purification device for a motor vehicle, which is switched off when a door of the motor vehicle is opened and unfiltered air enters.

Another system for air purification of a vehicle having an electrostatic filter is known from US 2018 037 093 A1.

In motor vehicles, filter arrangements or combination filters are usually used as air filters in the air conditioning system or an air conditioning unit, which can also be referred to as an air conditioner, such as pollen filters, activated carbon filters or layers, and anti-allergen filters or layers.

In addition, electrostatic filters can also be used for improved filter performance. Such electrostatic filters are operated using a high voltage, for example up to 20 kV. The electrostatic filters can be arranged, for example, in a water tank or an air intake tract of the air conditioning system.

### SUMMARY

The object underlying the invention is to improve the use of electrostatic filters in motor vehicles.

An air conditioning system for a motor vehicle is thus proposed, having
an air conditioning unit that is configured to condition interior supply air;
at least one air filter assigned to the air conditioning unit;
a blower device configured to generate an air flow that is conducted to the air conditioning unit;
at least one air supply duct connected to the blower device;
at least one electrostatic filter arranged in the air supply duct upstream of the blower device; and
a control device that is connected to the electrostatic filter.

It is provided that the control device is configured to control the operation of the electrostatic filter as a function of at least one detected air conditioning parameter and/or at least one vehicle status parameter.

This enables an improved use of an electrostatic filter in a motor vehicle, wherein the electrostatic filter can be set in an optimized manner for the respective conditions during vehicle operation.

The air conditioning system can have a fresh air duct and a recirculation air duct as air supply ducts. A respective electrostatic filter can be arranged in the fresh air duct and in the circulating air duct. This ensures that pollutants that enter the motor vehicle via both air inlets are only released into the interior of the motor vehicle in a filtered manner.

In the air conditioning system, the control device can be configured to activate a relevant electrostatic filter depending on a set air conditioning mode, in particular fresh air mode or recirculation mode or mixed mode. In this way, in particular, the energy consumption of the electrostatic filters can be optimized, which can, for example, also have a positive effect on the range of an at least partially electrically driven motor vehicle.

In addition, the control device can be configured to activate the two electrostatic filters simultaneously or intermittently in succession in the mixed mode.

In the air conditioning system, the control device can be configured to adjust the electrostatic filter as a function of a temperature value, in particular the interior temperature and/or the outside temperature, and/or an air humidity value. In this context, such values are understood as air conditioning parameters. This makes it possible to take into consideration the environmental conditions under which the electrostatic filter(s) are operated, so that, for example, a lower voltage is applied to the electrostatic filter under very humid conditions.

In the air conditioning system, the vehicle status parameter can be the opened and closed status of a hood of the motor vehicle. The control device can be configured to operate the electrostatic filter in limited operation or switch it off when the hood is open. This increases safety for an operator who has to carry out an action in the open engine compartment, such as checking the oil level, refilling washer fluid, taking out charging cables, and the like.

The control device can also be configured to continuously reduce the operation of the electrostatic filter over a certain period of time starting from full operation and to set it in limited operation or switch it off. For example, an initial very high voltage defined as 100% may be reduced over a certain period of time, for example to a limited or switched-off value of 0% to 20%. In this context, one can also say that the electrostatic filter is shut down with a kind of ramp or decay curve.

Furthermore, the control device can be configured to set the limited operation or switching off of the electrostatic filter depending on an air humidity value. For example, if a very high relative humidity is detected, the voltage applied to the electrostatic filter can be reduced more or even removed in order to ensure safety for an operator in a humid environment.

In this context, it can also be considered that the control device is configured to only release a lock of the hood after actuation of an unlocking device for the hood, for example an unlocking lever in the vehicle interior, when the voltage on the electrostatic filter has been reduced to a desired value.

A motor vehicle can be equipped with an above-described air conditioning system. The motor vehicle can be driven by an internal combustion engine or at least partially electrically. An internal combustion engine and/or an electric motor of the motor vehicle can be housed in the engine compartment, which is covered by a hood.

The control device of the air conditioning system can be part of a higher-level vehicle control device. Furthermore, a display can be present in the motor vehicle, which is configured to indicate the active or inactive operating status of an electrostatic filter.

A method for operating an air conditioning system described above comprises the following steps:
determining the status of a hood of the motor vehicle;
activating the operation of the electrostatic filter when the hood is closed;
limiting or deactivating the operation of the electrostatic filter when the hood is open, wherein a current operating status of the electrostatic filter is detected before the limiting or deactivating.

In the method, an air humidity value can be detected, wherein the electrostatic filter is limited or deactivated depending on the air humidity value.

Furthermore, the electrostatic filter can be deactivated in the method if the air humidity value exceeds a humidity threshold value. If, for example, the relative humidity is determined as the air humidity value, the humidity threshold value can be defined, for example, between 60% and 80%. It is also conceivable to adjust this humidity threshold value depending on the position of the motor vehicle and the associated climatic zone or the proximity to a sea or the like.

### BRIEF DESCRIPTION OF THE FIGURES

Further advantages and details of the invention result from the following description of embodiments with reference to the figures. In the figures:

FIG. 1 shows a simplified and schematic representation of an air conditioning system;

FIG. 2 shows a simplified and schematic representation of a motor vehicle having an air conditioning system;

FIG. 3 shows a simplified and schematic flow chart of a method for operating the air conditioning system.

### DETAILED DESCRIPTION

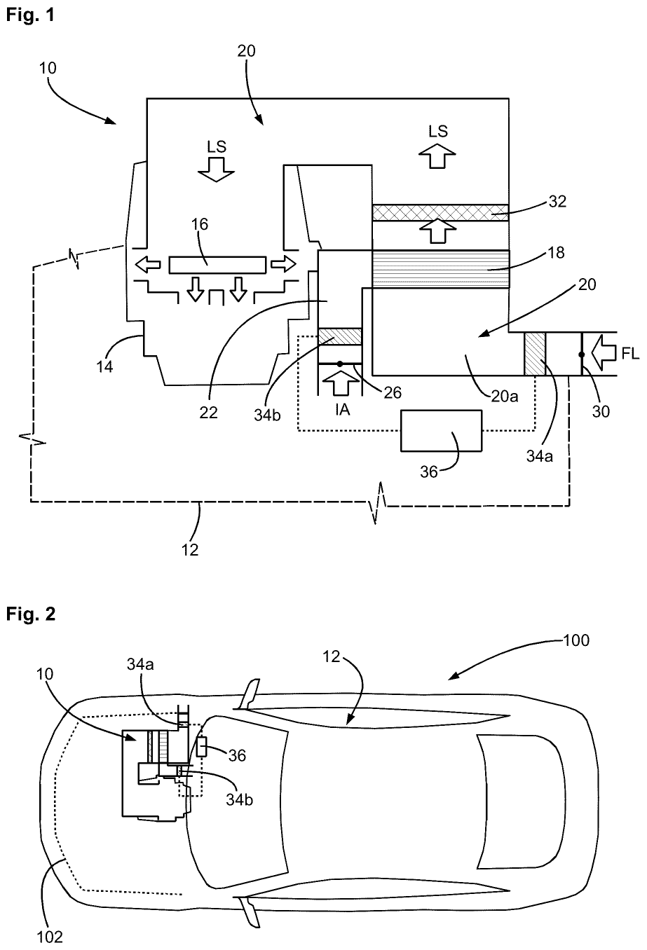

FIG. 1 shows a schematic and simplified representation of an air conditioning system 10 for a motor vehicle driven by an internal combustion engine or at least partially electrically. The illustration shows a kind of top view from above of the air conditioning system 10. An interior 12 or passenger compartment of the motor vehicle is indicated by a dashed line. The air conditioning system 10 comprises an air conditioning unit 14, which can also be referred to as an air conditioner or air conditioning module. An evaporator 16 is shown as an exemplary component of the air conditioning unit 14. The evaporator 16 is arranged in a refrigerant circuit (not shown further here).

The air conditioning system 10 furthermore comprises at least one blower device 18, which is shown in simplified form in FIG. 1 only as a horizontally hatched block. The blower device 18 is configured to generate an air flow LS, which is conducted to the evaporator 16 or the air conditioning unit 14. The blower device 18 is arranged upstream of the evaporator 16 or the air conditioner 14 in relation to the generated air flow LS.

The air conditioning system 10 furthermore comprises an air supply duct 20 connected to the blower device 18. A fresh air duct section 20a is arranged upstream of the blower device 18, which is connected to the air supply duct 20 or forms part of the air supply duct 20.

The air conditioning system 10 furthermore comprises an interior exhaust air duct section 22 connected to the air supply duct 20 upstream of the blower device 18.

The interior exhaust air duct section 22 is assigned an exhaust air flap device 26, which is configured to at least partially supply the interior exhaust air flow IA to the blower device 18.

The fresh air duct section 20a is assigned a fresh air flap device 30, which is configured to at least partially supply the fresh air flow FL to the blower device 18.

Depending on the position of the exhaust air flap device 26 or the fresh air flap device 30, the air conditioning system 10 can be operated in solely a fresh air mode, solely a recirculation mode, or a mixed mode.

At least one air filter 32, for example a pollen filter, activated carbon filter, or the like, can be arranged downstream of the blower device 18, so that air conveyed by the blower device 18 reaches the air conditioner 14 or the evaporator 16 in a filtered or purified manner.

At least one electrostatic filter can be arranged in the air supply channel 20 upstream of the blower device 18. In the example shown here, a first electrostatic filter 34a is arranged in the fresh air duct section 20a. Furthermore, a second electrostatic filter 34b is arranged in the interior exhaust air duct 22. It is to be noted that the arrangement of a respective electrostatic filter 34a, 34b in the fresh air or interior exhaust air duct 20a, 22 is not mandatory. The air conditioning device presented here can also have only a single electrostatic filter, which is arranged, for example, in the fresh air duct section 20a.

The air conditioning system 10 comprises a control device 36 which is connected to the at least one electrostatic filter 34a, 34b, which is illustrated by dashed lines in FIG. 1. The control device 36 is in particular configured to control the operation of the at least one electrostatic filter or of both electrostatic filters 34a, 34b shown in the example as a function of at least one detected air conditioning parameter and/or at least one vehicle status parameter.

FIG. 2 shows a simplified representation of a motor vehicle 100, which is equipped with an above-described air conditioning system 10. The motor vehicle 100 has a cover or hood 102 in the front area, which is indicated by a dashed line. A vehicle status parameter that can be taken into consideration by the control device 36 of the air conditioning system 10 can be the opened or closed status of the hood 102 of the motor vehicle 100.

The control device 36 can be configured to operate the electrostatic filter 34a, 34b in limited operation or switch it off when the hood 102 is open. The control device 36 can additionally be configured to continuously reduce the operation of the electrostatic filter 34a, 34b over a certain period of time starting from full operation and to set it in limited operation or switch it off.

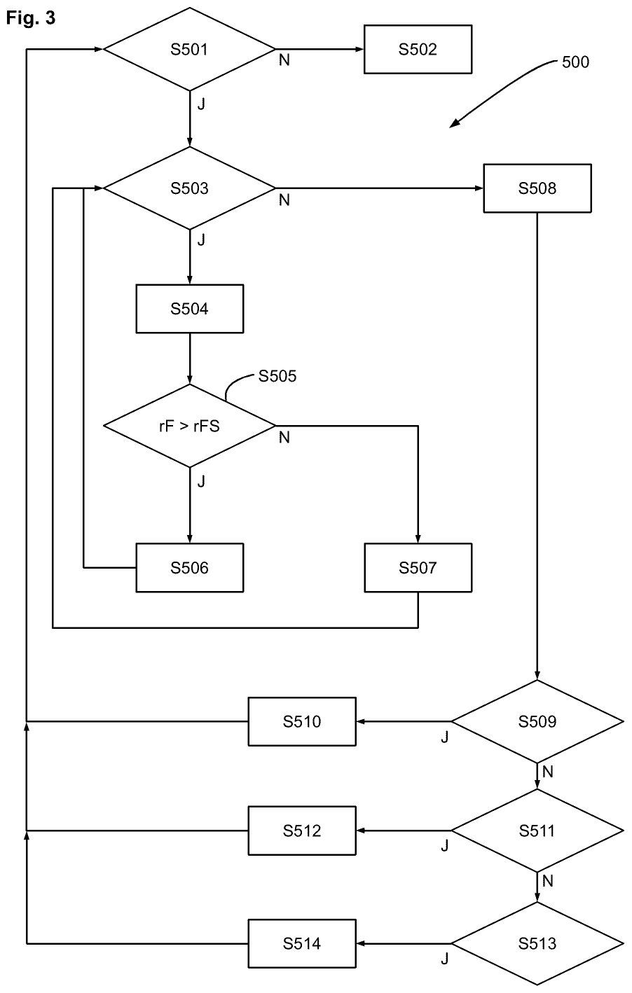

FIG. 3 shows a schematic and simplified flow chart of a method 500 for operating an above-described air conditioning system 10 in a motor vehicle 100.

In the method 500 for operating the air conditioning system 10, in a step S501 it is determined or a request is made that the electrostatic filter or electrostatic filters 34a, 34b of the air conditioning system 10 should or should not be operated. According to step S502, the electrostatic filter 34a, 34b is switched off. It is noted that for the sake of simplicity purposes, the term “the electrostatic filter” is used hereinafter, although the air conditioning system 10 can have multiple electrostatic filters.

If the electrostatic filter 34a, 34b is to be activated, it is checked in a step S503 whether the cover or hood 102 of the motor vehicle 100 is open. When the hood 102 is opened, a current operating status, such as the electrical power consumption or the electrical operating voltage, of the electrostatic filter 34a, 34b is detected in step S504. The operating status or the operating voltage can, for example, be in a range from 20% to 100%. In other words, the electrostatic filter 34a, 34b is in full operation (100%) or partial load operation (<100%).

In a step S505, it is checked whether a relative humidity IF exceeds a humidity threshold rFS. If the threshold value rFS is exceeded, the electrostatic filter 34a, 34b is switched off or inactivated (with the hood 102 open) in step S506. If the threshold value rFS is not reached, the operating status, in particular the operating voltage of the electrostatic filter 34a, 34b, is set to, for example, 20%.

The reduction to partial load operation of the electrostatic filter 34a, 34b according to step S507 can take place continuously over a certain period of time starting from full operation. For example, an initial very high voltage set as 100% may be reduced over a certain period of time, for example to a limited or switched-off value of 0% to 20%. In this context, one can also say that the electrostatic filter is shut down with a kind of ramp or decay curve.

In simple terms, it can also be said that the electrostatic filter 34a, 34b should always be switched off at high relative humidity with the hood 102 open, with the electrostatic filter 34a, 34b continuing to be activated or remaining activated at low relative humidity in partial load operation.

If the cover or hood 102 is open, after steps S506 or S507 have been carried out, a new query is made according to step S503 as to whether the hood 102 is still open or not.

If the cover or hood 102 of the motor vehicle 100 is closed, which is checked in step S503, the electrostatic filter 34a, 34b is activated or switched on (again) in step S508.

In a step S509, it is checked whether the air conditioning system 10 is or should be operated in solely a fresh air mode. If this is the case, according to step S510, the electrostatic filter 34a in the fresh air duct section 20a is activated and the electrostatic filter 34b in the interior exhaust air duct section 22 is deactivated. If solely a fresh air mode is not available or requested, it is checked in step S511 whether the air conditioning system 10 is or should be operated solely in recirculation mode. If this is the case, according to step S512, the electrostatic filter 34a in the fresh air duct section 20a is deactivated and the electrostatic filter 34b in the interior exhaust air duct section 22 is activated.

If solely a recirculation mode is not available or requested, a mixed mode is assumed in step S513. According to step S514, the electrostatic filter 34a in the fresh air duct section 20a and the electrostatic filter 34b in the interior exhaust air duct section 22 can be activated. In particular, according to step S514, the control device 36 of the air conditioning system 10 can be configured to activate the two electrostatic filters 34a, 34b simultaneously or intermittently in succession in mixed operation.

In the method 500 presented, the control device 36 can also be configured to adjust the electrostatic filter(s) 34a, 34b depending on a temperature value, in particular the interior temperature and/or the outside temperature, and/or an air humidity value.

From steps S510, S512, and S514, as part of method 500, it is possible to start again at step S501, in which it is determined whether activation of the electrostatic filter (s) 34a, 34b is still required or should be maintained.

1-14. (canceled)

15. An air conditioning system for a motor vehicle, comprising:
an air conditioning unit that is configured to condition interior supply air;
at least one air filter assigned to the air conditioning unit;
a blower device configured to generate an air flow that is conducted to the air conditioning unit;
at least one air supply duct connected to the blower device;
at least one electrostatic filter arranged in the air supply duct upstream of the blower device;
a control device that is connected to the electrostatic filter;
wherein the control device is configured to control the operation of the electrostatic filter as a function of at least one detected air conditioning parameter and/or at least one vehicle status parameter.

16. The air conditioning system according to claim 15, further comprising: a fresh air duct and a circulating air duct as air supply ducts.

17. The air conditioning system according to claim 16, further comprising: a respective electrostatic filter arranged in the fresh air duct and in the circulating air duct.

18. The air conditioning system according to claim 17, wherein the control device is configured to activate a relevant electrostatic filter depending on a set air conditioning mode, in particular fresh air mode or recirculation mode or mixed mode.

19. The air conditioning system according to claim 18, wherein the control device is configured to activate the two electrostatic filters simultaneously or intermittently in succession in the mixed mode.

20. The air conditioning system according to claim 15, wherein the control device is configured to adjust the electrostatic filter as a function of a temperature value, in particular interior temperature and/or outside temperature, and/or an air humidity value.

21. The air conditioning system according to claim 15, wherein the vehicle status parameter is the opened and closed status of a hood of the motor vehicle.

22. The air conditioning system according to claim 21, wherein the control device is configured to operate the electrostatic filter in a limited operation or switch it off when the hood is open.

23. The air conditioning system according to claim 22, wherein the control device is configured to continuously reduce the operation of the electrostatic filter over a certain period of time starting from full operation and to set it in limited operation or switch it off.

24. The air conditioning system according to claim 22, wherein the control device is configured to set the limited operation or the switching off of the electrostatic filter depending on an air humidity value (rF).

25. A motor vehicle having an air conditioning system according to claim 15.

26. A method for operating an air conditioning system according to claim 15, comprising the following steps:
determining the status of a hood of the motor vehicle;
activating the operation of the electrostatic filter when the hood is closed;
limiting or deactivating the operation of the electrostatic filter when the hood is open, wherein a current operating status of the electrostatic filter is detected before the limiting or deactivating.

27. The method according to claim 26, wherein an air humidity value (rF) is detected and wherein the limiting or deactivating of the electrostatic filter takes place depending on the air humidity value (rF).

28. The method according to claim 27, wherein the electrostatic filter is deactivated when the air humidity value (rF) exceeds a humidity threshold value (rFS).

29. The air conditioning system according to claim 16, wherein the control device is configured to adjust the electrostatic filter as a function of a temperature value, in particular interior temperature and/or outside temperature, and/or an air humidity value.

30. The air conditioning system according to claim 17, wherein the control device is configured to adjust the electrostatic filter as a function of a temperature value, in particular interior temperature and/or outside temperature, and/or an air humidity value.

31. The air conditioning system according to claim 18, wherein the control device is configured to adjust the electrostatic filter as a function of a temperature value, in particular interior temperature and/or outside temperature, and/or an air humidity value.

32. The air conditioning system according to claim 19, wherein the control device is configured to adjust the electrostatic filter as a function of a temperature value, in particular interior temperature and/or outside temperature, and/or an air humidity value.

33. The air conditioning system according to claim 16, wherein the vehicle status parameter is the opened and closed status of a hood of the motor vehicle.

34. The air conditioning system according to claim 17, wherein the vehicle status parameter is the opened and closed status of a hood of the motor vehicle.
